(19) United States
(12) Patent Application Publication
(10) Pub. No.: US 2006/0205917 A1
(43) Pub. Date: Sep. 14, 2006

(54) Catalyst complex for catalysing esterification and trans-esterification reactions and process for esterification/trans-esterification using the same

(76) Inventors: Jamil A Siddiqui, Ri yadh (SA); Khaled Al-Luhaidan, Riyadh (SA); Bander Alfarhood, Riyadh (SA); Rainer Gutmann, Denkendorf (DE); Aref Uria, Denkendorf (DE); Michael Schweizer, Dekendorf (DE); Andreas Fritz, Dekendorf (DE)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 10/542,439

(22) PCT Filed: Jan. 23, 2003
(86) PCT No.: PCT/EP03/00629

§ 371 Date: Feb. 13, 2006

(51) Int. Cl. B01J 31/00; C08G 63/87

(52) U.S. Cl. 528/279; 502/159; 502/152; 502/103

(57) ABSTRACT

The present invention relates to a novel catalyst complex for catalysing esterification and trans-esterification reactions, comprising: (i) a polymeric titanium glycolate having the formula [TᵢO₄(CH₂)₄]ₙ wherein n=1 to 200; and (ii) an alkali metal glycolate; wherein the molar ratio of the polymeric titanium glycolate and the alkali metal glycolate is about 1.25:1 to about 100:1, preferably about 1.25:1 to about 10:1; and to a process for esterification of a dicarboxylic acid compound and an dialcoholic compound, followed by polycondensation to form a polyester.

The present invention relates to a catalyst complex for catalysing esterification and trans-esterification reactions and a process for an esterification/trans-esterification using the same.

Polyesters and copolyesters are known which represent important polymeric materials for various applications. They are prepared by the reaction of a dicarboxylic acid, preferably an aromatic acid such as terephthalic acid, with a dihydroxy compound, preferably an aliphatic dihydroxy compound such as ethylene glycol, preferably in the presence of a catalyst.

Thermoplastic polyesters are very important polymer materials, produced commercially in large quantities. Linear thermoplastic polyesters such as poly(ethylene terephthalate) (PET) are used in a variety of forms. For example, they may be used in the form of synthetic fibers, which exhibit good resistance to most mineral acids and exhibit excellent resistance to cleaning solvents and surfactants. Thermoplastic polyesters are also used to a great extent as molding materials. Such materials are characterized by many desirable properties, such as hardness, strength, toughness, good chemical resistance, and low moisture absorption.

The production of polyesters, e.g. PET, by polycondensation of diols and alkyl or aryl diacids is well known in the art, as described in the Encyclopaedia of Polymer Science and Engineering, 2^{nd} ed, volume 12, John Wiley and Sons, New York (1988). PET is generally formed into a low molecular weight prepolymer [bis(hydroxyalkyl)ester and oligomers] by converting terephthalic acid with ethylene glycol or by transesterification of dimethyl terephthalate with ethylene glycole in the presence of what is generally called a first stage catalytic additive. The prepolymer is subsequently subjected to polycondensation by esterification and transesterification reactions to form a high molecular weight polyester. Because the transesterification is an inherently slow reaction, which requires holding the reactants at elevated temperatures for protracted periods with concomitant thermal degradation, the polycondensation step is generally catalysed.

It is, however, highly desirable to produce a polyester with high molecular weight and low yellowness at a rate as high as possible. Yellowness in polyesters is normally a result of polymer degradation and side reactions occurring during either polymerisation or down-stream processing. Thus yellowness in the polymer as synthesized is indicative not only of the quality of the polymer so-produced, but also of further processability of the polymer into fabricated forms in colour-sensitive applications such as fibers, films, and certain molded parts. While many catalysts for production of high molecular weight polyesters are known, they suffer from a deficiency in either rate of conversion, ease of use, or quality of the product formed therewith.

Antimony-containing compounds are currently in wide-spread commercial use as catalysts which provide a desirable combination of high reaction rate and low colour. However, there is considerable inducement to find a substitute for antimony because of the expense and difficulty of handling the toxic antimony in an environmentally responsible manner.

Titanium-based compounds are often used to catalyse polycondensation reactions. These catalysts are non-toxic and their reactivity is even better than the one of antimony catalysts, but it was observed that they cause an undesired yellowish colorization of the polyester.

Some patents comprise a method for producing polyesters and copolyesters in which a titanium compound and an alkalimetal compound are used as catalysts. WO98/56848 discloses coprecipitates as polycondensation catalysts. DE 195 13 056 A1 discloses catalysts on the basis of titanium dioxide or a titanate compound as precipitates. Further in Japanese patent Application 52148593 A the preperation of polyesters is disclosed in the presence of an alkali metal compound by the use of a specific complex compound containing titanium as a catalyst.

In Textil Praxis International 1, 1989, pp. 29-33, a catalyst having equimolar amounts of a titanium glycolate and an alkali metal glycolate is disclosed leading to polyesters with insufficient molecular weight.

It is therefore an object of the present invention to provide a catalyst for catalysing esterification and trans-esterification reactions overcoming the disadvantages mentioned in the prior art, especially to form a polyester with low catalyst concentrations in short reaction times with improved polyester properties, such as reduced yellowish colour and increased molecular weight.

It is another object of the present invention to provide a process for making polyester using the novel catalyst complex.

The first object is achieved by a catalyst complex for catalysing esterification/trans-esterification reactions, comprising:
i) a polymeric titanium glycolate having the formula (TiO₄(CH₂)₄]ₙ wherein n=1 to 200; and
ii) an alkali metal glycolate
   wherein the molar ratio of the polymeric titanium glycolate and the alkali metal glycolate is about 1.25:1 to about 100:1, preferably about 1.25:1 to about 10:1.

Preferably, the alkali metal is sodium and the glycolate has the formula Na—O—CH₂—CH₂—OH.

More preferably, the total content of the metals of the catalyst in a mixture of esterification components is 1 to about 70 ppm, preferably about 10 to about 50 ppm, referred to the acid esterification component.

For the second object, normally to make polyesters using the catalyst complex, first a dicarboxylic acid is esterified with a diol, followed by trans-esterification. The catalyst complex is active in both reactions. The carboxylic acid compound is a dicarboxylic acid of the formula HOOC—R—COOH, wherein R is, linear or branched, an alkylen group, an arylene group, and alkenylen group, or a combination thereof.

Preferably R has about 2 to about 30, preferably about 4 to about 15 carbon atoms.

Furthermore, it is preferred that the carboxylic acid compound is selected from the group comprising terephthalic acid, isophthalic acid, naphthalenic diacid, succinic acid, adipic acid, phthalic acid, glutaric acid, oxalic acid, maleic acid, and combinations thereof.

Most preferred is, that the carboxylic acid compound is terephthalic acid.

Still preferred the carboxylic acid compound is an oligomer having repeating units derived from a carboxylic acid.

It is still preferred, that the alcoholic compound is an alkylene glycol of the formula HO—R′—OH, a polyalkylene glycol having the formula HO—[R″—O—]ₙ—H, or combinations thereof, wherein R′ is an alkylene group, linear or branched, having 2 to about 10, preferably 2 to 4 carbon atoms, and wherein R″, being the same or different, is an alkylene group having 1 to about 10, preferably 1 to 5 carbon atoms.

Further, the alcoholic compound may be selected from the group comprising ethylene glycol, propylene glycol, isopropylene glycol, butylene glycol, 1-methyl propylene glycol, pentylene glycol, neopentylene glycol, and combinations thereof.

Moreover, in a further embodiment it is preferred, that the process is carried out at a temperature of about 150° C. to about 500° C., preferably 250° C. to 300° C.

In another embodiment, the process is carried out at a pressure of about 0.001 to about 10 atmospheres.

Further, the molar ratio of the alcoholic compound to the carboxylic acid compound may be in the range of about 0.1:1 to about 10:1, preferably about 1:1 to about 3:1.

It is preferred, that the catalyst is present in the range of about 1 to about 70 ppm of esterification components, preferably about 10 to about 50 ppm, referred to the acid esterification component.

Advantageously, the process may be used for the preparation of poly(ethylene terephthalate).

Surprisingly, it was found that the catalyst complex according to the present invention may form polyesters at high yields in short reaction times. Further, the catalyst complex of the present invention prevents an undesired yellowing of the polyester formed. The molecular weight of the polyester obtained is in a range even higher than for an antimony based catalyst complex and is therefore highly suitable for industrial applications. Further, in the present innovation much higher molecular weights are obtained than with prior art (TPI 1, 1989, pp. 29-33). Additionally, only low catalyst concentrations are needed and hence the total metal content in the polymer is low.

The polymeric titantium glycolate for the inventive catalyst complex has the structural formula: 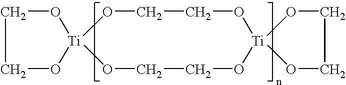
wherein n=0 to 200.

The polymeric titanium glycolate, which is not soluble in ethylene glycol can be dissolved by adding an alkali metal glycolate to form a complex between the titanium glycolate and the alkali metal glycolate. This catalyst complex may be used, in solution or as a solid, for the preparation of polyesters or copolyesters.

The polymeric titanium glycolate may be synthesised, for example, by converting titanium butylate with ethylene glycol. The alkali metal glycolate can be produced by dissolving elemental alkali metal in ethylene glycol. Titanium glycolate as a polymeric compound can not be dissolved in ethylene glycol. By adding a solution of alkali metal glycolate in ethylene glycol to titanium glycolate a complex is formed which may be dissolved in ethylene glycol obtaining a clear catalyst solution. The complex compound can be precipitated by distilling of ethylene glycol and may be used as a solid as well as a solution in ethylene glycol.

The present invention is further illustrated by the following examples, which are not to be construed as to unduly limit the scope of the invention.

### EXAMPLE 1

### Preparation of a Ti/Na-glycolate

1.1 Synthesis of Titanium Glycolate

A 500 ml three-necked flask with stirrer, gas inlet for nitrogen and distilling connection tube is filled with 68.0 g (0.2 mole) of Ti-butylate and 124.2 g (2.0 mole) of ethylene glycole. This clear solution is mixed by stirring for 5 min. Under a slow flow of nitrogen the mixture is heated up to 160° C. (oil bath temperature). While heating a white solid starts to precipitate. n-Butyl alcohol, which is built during the reaction, is distilled of The time of reaction is about 9 h. Sometimes it is necessary to increase the temperature of the oil bath up to 180° C. to get the theoretical amount of n-butyl alcohol, which is 59.3 g (0.8 mole). The flask is closed with stoppers, and reaction mixture is cooled over night. 100 ml of ethyl acetate are added to that mixture and stirred for 5 min. The solid is filtered off through a G3 frit and washed with 50 ml of ethyl acetate. The product is dried in a desiccator over phosphorus (V) oxide and afterwards for 3 h under vacuum (0.1 mbar) at 60° C. The yield is 33.5 g (0.199 mole/99.7%).

1.2 Synthesis of Sodium Glycolate

In a 500 ml three-necked-flask with stirrer, high-efficiency condenser and gas-inlet for nitrogen, 155.18 g (2.5 mole) of ethylene glycole (MEG) are placed and stirred under N₂-inlet for 15 min. 11.5 g (0.5 mole) of elementary sodium are cut by knife to 0.5 g (0.02 mole) pieces. They are carefully added to the MEG. Development of a small amount of hydrogen can be observed. The mixture is then carefully heated up to 80° C. until the total amount of sodium is dissolved. This might occur very fast.

1.3 Synthesis of Ti/Na-glycolate Complex (here Molecular Ratio 2:1)

In a 100 ml Erlenmeyer flask equipped with a ground in stopper and placed on a magnetic stirrer 0.2360 g (1.4*10⁻³ mole) of Ti-glycolate and 35 g (0.56 mole) of ethylene glycole are added. The mixture is heated to 120° C. and 5.9046 g of a 1 wt-% solution of Na-glycolate in ethylene glycole (0.0590 g=0.7*10⁻³ mole Na-glycolate) is added. The suspenion changes into a clear solution within about 5 min.

### EXAMPLE 2

### Synthesis of poly(ethylene terephthalate)

A 2 l reactor equipped with a stirrer and a torque measurement unit is charged with 778.09 g (4.68 mole) of terephthalic acid, 377.90 g (6.09 mole) of ethylene glycol and a specific amount of a solution of a catalyst in ethylene glycole, e.g. the catalyst complex mentioned in example 1.3. Temperature is increased up to 235° C. within 60 minutes and pressure develops around 9 bar. Further, pressure is reduced down to atmosphere within 1 h 30 min and amount of condensate is collected in a flask. After completion of the pre-esterification reaction, temperature is increased to 260° C. within 30 minutes. Temperature is maintained at 260° C. for 30 minutes and pressure is reduced to 7 mbar. Further, temperature is increased to 275° C. within 10 minutes and pressure is reduced below 10⁻² mbar. At this moment measurement of time for polycondensation is started. Temperature is maintained at 275° C. till desired torque of stirrer is obtained (7.5 Nm≡about 24,000 g/mol). Condensate can be collected using an ice bath after polycondensation process and granulated. All products were analysed for conversion in terms of number average molecular weight via intrinsic viscosity and colour after complete crystallization of PET.

The example number, the catalyst systems used to polymerise the master batch, the polymer products' L*, a* and b* colour numbers, the time for polycondensation and number average molecular weight are described in the following Table 1,

where at CIE color scale:
L* (lightness) axis—0 is black, 100 is white
a*(red-green) axis—positive values are red; negative values are green and 0 is neutral

b*(blue-yellow) axis—positive values are yellow; negative values are blue and 0 is neutral.

| | Catalyst- | | | | | |
|---|---|---|---|---|---|---|
| | PPM | | | | | |
| | (referred to | | | | | |
| | esterification | | | | | |
| | component/ | | | | | Molecular |
| | here | | | | Time for | Weight |
| | terephthalic | | | | Poly- | Mₙ |
| Example | acid) | L* | a* | b* | kondensation | [g/mol] |
| 1 | 300 ppm | 81.1 | −1.9 | −0.8 | 1 h 39 min | 23,200 |
| | Sb₂Ac₃ | | | | | |
| 2 | 300 ppm | 78.4 | −1.3 | 8.7 | 1 h 38 min | 23,100 |
| | Ti-glycolate | | | | | |
| 3 | 300 ppm | 81.0 | −1.6 | 4.3 | 1 h 56 min | 23,900 |
| | Ti-glycolate | | | | | |
| | 150 ppm | | | | | |
| | Na-glycolate | | | | | |
| 4 | 409 ppm | 80.5 | −1.1 | 3.2 | 1 h 24 min | 24,100 |
| | Ti-glycolate | | | | | |
| | 40,9 ppm | | | | | |
| | Na-glycolate | | | | | |
| 5 | 20 ppm | 81.7 | −1.7 | −0.2 | 3 h 30 min | 20.600 |
| | Sb₂Ac₃ | | | | | |
| 6 | 20 ppm | 83,9 | −2.1 | 2.2 | 2 h 26 min | 24,000 |
| | Ti-glycolate | | | | | |
| 7 | 50 ppm | 83.1 | −2.8 | 4.0 | 1 h 25 min | 24,200 |
| | Ti-glycolate | | | | | |
| | 40 ppm | | | | | |
| | Na-glycolate | | | | | |
| 8 | 40 ppm | 83.7 | −2.2 | 1.2 | 1 h 22 min | 23,500 |
| | Ti-glycolate | | | | | |
| | 30 ppm | | | | | |
| | Na-glycolate | | | | | |
| 9 | 30 ppm | 82.6 | −2.6 | 1.0 | 1 h 27 min | 24,400 |
| | Ti-glycolate | | | | | |
| | 20 ppm | | | | | |
| | Na-glycolate | | | | | |
| 10 | 20 ppm | 85.3 | −2.3 | 0.9 | 1 h 34 min | 24,000 |
| | Ti-glycolate | | | | | |
| | 10 ppm | | | | | |
| | Na-glycolate | | | | | |

It was found, that by using the catalyst system Ti/Na-glycolate in various compositions (examples 3,4 and 7-10) time for polycondensation is in the same order compared with time for polycondensation in the case of commercially used antimony catalyst with 300 ppm (referred to terephthalic acid) (example 1). It is disclosed in table 1 that for lower catalyst concentrations the molecular weight of the polyester obtained with antimony catalyst (example 5) is 20,600 g/mol and time for polycondensation is 3 h 30 min, whereas the molecular weight using Ti-glycolate catalyst (example 6) is 24,000 g/mol and time for polycondensation is shorter (2 h 26 min). By using catalyst complex system with lower concentrations (examples 7-10) time for polycondensation is lower and molecular weight is higher than by using 300 ppm antimony catalyst. The yellowish colour in case of manufacturing PET, which is high by using pure Ti-glycolate (example 2, b*-value 8,7) can be dramatically reduced by using the catalyst system Ti/Na-glycolate (examples 3, 4 and 7-10) or by decreasing the catalyst concentration (example 6).

The features disclosed in the foregoing description and in the claims may, both separately and in any combination thereof, be material for realizing the invention in diverse forms thereof.

1. A catalyst complex for esterification and trans-esterification reactions, comprising:
i. a polymeric titanium glycolate represented by the formula [TiO₄(CH₂)₄]ₙ wherein n=1 to 200; and
ii. an alkali metal glycolate,
wherein the molar ratio of the polymeric titanium glycolate and the alkali metal glycolate is about 1.25:1 to about 100:1.

2. The catalyst complex according to claim 1, wherein the alkali metal glycolate is represented by the formula Na—O—CH₂—CH₂—OH.

3. The catalyst complex according to claim 1, wherein the molar ratio of the polymeric titanium glycolate and the alkali metal glycolate is about 1.25:1 to about 10:1.

4. A process for the esterification of a dicarboxylic carboxylic acid compound and an alcohol compound comprising contacting a process feed comprising a dicarboxylic acid compound and an alcohol compound with the catalyst complex of claim 1, wherein the dicarboxylic acid compound is represented by the formula HOOC—R—COOH, wherein R is, is a linear or branched, alkyl, alkenyl or aryl group containing 2 to 30 carbon atoms.

5. The process according to claim 4, wherein R contains 4 to 15 carbon atoms.

6. The process according to claim 4, wherein the dicarboxylic acid compound is selected from the group consisting of terephthalic acid, isophthalic acid, naphthalenic diacid, succinic acid, adipic acid, phthalic acid, glutaric acid, oxalic, acid and maleic acid.

7. The process according to claim 6, wherein the dicarboxylic acid compound is terephthalic acid.

8. The process according to claim 4, wherein the dicarboxylic acid compound is an oligomer having repeating units derived from a carboxylic acid.

9. The process according to claim 4, wherein the alcohol compound comprises an alkylene glycol represented by the formula HO—R′—OH or a polyalkylene glycol represented by the formula HO—[R″—O—]ₙ—H, wherein R′ is a linear or branched alkyl group, having 2 to 10 carbon atoms, and wherein R″, is an alkyl group having 1 to 10 carbon atoms.

10. The process according to claim 6, wherein the alcohol compound is selected from the group consisting of ethylene glycol, propylene glycol, isopropylene glycol, butylene glycol, 1-methyl propylene glycol, pentylene glycol, neopentylelne glycol, and combinations thereof.

11. The process according to claim 4, wherein the process is carried out at a temperature of about 150° C. to about 500° C., and at a pressure of about 0.001 atmosphere to about 10 atmospheres.

12. The process according to claim 10, wherein the process is carried out at a temperature of about 250° C. to about 300° C. and a pressure of about 0.001 atmospheres to about 10 atmospheres.

13. The process according to claim 4, wherein the molar ratio of the alcohol compound to the dicarboxylic acid compound is in the range of about 0.1:1 to about 10:1.

14. The process according to claim 4, wherein the catalyst complex is present in a concentration of about 1 ppm to about 70 ppm in the process feed.

15. (canceled)

16. The catalyst complex of claim 3, wherein the alkali metal glyocloate is represented by the formula Na—O—CH₂—CH₂—OH.

17. The process according to claim 7, wherein the alcohol compound comprises ethylene glycol.

18. The process according to claim 10, wherein the molar ratio of the alcohol compound to the dicarboxylic compound in the process feed is in the range of about 1:1 to about 3:1.

19. The process according to claim 4, wherein the catalyst complex is present in a concentration of about 1 ppm to about 50 ppm in the process feed.

20. The process according to claim 9, wherein the catalyst complex is present in a concentration of about 1 ppm to about 50 ppm in the process feed.

21. The process according to claim 12, wherein the catalyst complex is present in a concentration of about 1 ppm to about 50 ppm in the process feed.
